(19) United States
(12) Patent Application Publication
(10) Pub. No.: US 2001/0056549 A1
(43) Pub. Date: Dec. 27, 2001

(54) Method of providing access control for and/or vis-a-vis users accessing the internet from terminals via a private access node, and arrangements for putting this kind of method into practice

(75) Inventors: Francis Pinault, Bois-Colombes (FR); Alain Guirauton, Argenteuil (FR)

Correspondence Address: SUGHRUE, MION, ZINN, MACPEAK & SEAS, PLLC, 2100 Pennsylvania Avenue, N.W., Suite 800, Washington, DC, 20037-3213, US

(73) Assignee: ALCATEL

(21) Appl. No.: 09/873,357

(22) Filed: Jun. 5, 2001

(30) Foreign Application Priority Data
Jun. 8, 2000 (FR) 00 07 351

(51) Int. Cl. H04L 9/00

(52) U.S. Cl. 713/201

(57) ABSTRACT

A method is disclosed of controlling access for and/or vis-à-vis users who access a computer network enabling exchange of information, in particular the Internet, using terminals and via an access node that is shared or specific to an organization, for example a company's private automatic branch exchange, to which the terminals are connected to access the computer network via a server. The method temporarily stores, for downstream filtering, the multimedia data stream received from the computer network and addressed to a user terminal in response to an access request formulated from that terminal. The downstream filtering is applied in particular by means of an arrangement for authorizing or blocking transmission of the data stream to the terminal as a function of particular criteria. The criteria are independent of the terminal and the access provider.

### BACKGROUND OF THE INVENTION

1. Field of the Invention

The invention relates to a method of providing access control for and/or vis-à-vis users who access a computer network, such as the Internet in particular, via a private access node, such as a company's private automatic branch exchange. It also relates to various organized arrangements for putting the method according to the invention into practice.

To be more specific, the invention is intended to be used by organizations, and in particular by companies, whose users are equipped with terminals enabling them to access a computer network, and in particular a computer network external to their organization, such as the Internet, such access being obtained via a private access node at least partly reserved to the organization concerned.

This applies, for example, if the organization has an internal communication structure, for example a cable or wireless communication network including at least one access node, as defined above, through which users obtain access from terminals specific to the organization. The access node is a private automatic branch exchange (PABX), for example, and in particular a multimedia PABX that the organization uses for its communications, or a gateway type private access structure to a local area network (LAN).

For various reasons, and for economic reasons in particular, it is important for an organization to be able to verify that the facilities it offers to access a computer network, and in particular the Internet, are used in an appropriate manner, in particular avoiding costs and additional costs that are inappropriate for the organization, and unjustified material or financial risks.

2. Description of the Prior Art

One prior art access control solution, derived from what was previously provided in the field of telephony, consists of prohibiting some kinds of access to users when they are operating terminals of an organization. In this way it is possible to prevent access to certain sites of a computer network or to certain types of information from the terminals of an organization, by employing filters to filter the addresses of the sites, for example in a so-called “firewall” unit between the computer network and the access node used by the terminals to access the computer network.

However, this solution is not really satisfactory in that it entails continuous updating of prohibited addresses, which is difficult to achieve in the case of access to sites of a network that is constantly changing, like the Internet, given the possibilities of rerouting between sites that this kind of network provides. What is more, this kind of filtering is effective only under predetermined conditions and remains ineffective otherwise, and it must therefore be regularly updated so that it can adapt to technical advances.

Some multimedia files can be downloaded subject to a payment, conferring rights for limited use. It is known in the art to identify such multimedia files with an SDMI signature which is used to monitor the use of the files after they are downloaded. A member of an organization can exceed their rights of use and this can engage the liability of the organization. An organization therefore runs risks if it receives such files, following requests for access effected from its terminals.

U.S. Pat. No. 5,987,606 describes a filter located in the server of an Internet service provider. It can detect prohibited words or phrases. The prohibited words or phrases are predetermined for each client able to connect to the Internet via the service provider. This solution is very suitable for private individuals but is not very suitable for an organization.

### SUMMARY OF THE INVENTION

The invention therefore proposes a method of providing access control for and/or vis-à-vis users who access a computer network enabling exchange of information, in particular the Internet, by means of terminals, via a private access node, shared or specific to an organization, such as a company, to which the terminals are connected to access the computer network via an access server, which method stores temporarily for downstream filtering the stream of multimedia data received from the computer network addressed to a user terminal in response to an access request formulated from the terminal, the downstream filtering being applied by an arrangement for authorizing or blocking transmission of the data stream to the terminal as a function of particular criteria applied to the received data stream at the private access node.

The above method therefore enables an organization to filter everything that enters the computer network of the organization, independently of the Internet service provider or providers, because the filtering is performed at the private access node. Also, it is possible to define filter criteria specific to an organization but independent of the identity of members of the organization.

In the method according to the invention the data received from the computer network is stored temporarily before it is transmitted to the user terminal or not, depending on the results of an analysis.

In the method according to the invention data received from the computer network that is not transmitted, following an analysis that leads to a decision not to transmit it to the user, is retained so that the data can be compared with data of a subsequent data stream to accelerate decision-making in the case of identical data in different data streams, for a particular set of data, without having to carry out a further analysis corresponding to that which led to the data that is retained not being transmitted.

In one embodiment of the method according to the invention transfer of data received from the computer network to a user terminal is temporarily delayed in the temporary storage means pending determination of conformance of what has been received with particular standards and then transmitted to the terminal if conformance is found.

Temporarily delayed data relating to a data stream stored in the conformance determination phase can also be retained to enable a further check in the event of non-conformance, either in respect of data received on detection of non-conformance, in which case the data stream that transmits it from the computer network is interrupted, or in respect of all of the data received, without the data stream being interrupted.

Data for which and/or for the source of which non-conformance has been detected in a received data stream can also be retained to enable interruption of a data stream subsequently received before complete analysis of the data that the data stream transmits if the data and/or the source are detected again in the stream subsequently received.

The method according to the invention includes counting, for control purposes, a particular content, consisting of a characteristic combination of data, if the content is found in the temporarily stored data, after it has been received from the computer network in at least one data stream addressed to a particular terminal.

Another embodiment of the method according to the invention includes signature analysis for at least temporarily blocking transmission of data received from the network to a user terminal if the data incorporates a signature characteristic of restricted signaling rights.

It also includes an identifier search analysis applied to received data addressed to a user terminal to authorize transmission of the data to the terminal if one or more particular identifiers are found in the received data addressed to the terminal.

The invention also provides an arrangement for providing access control for and/or vis-à-vis users who access a computer network enabling exchange of information, in particular the Internet, from terminals via a private access node that is shared or specific to an organization, such as a company, and to which the terminals are connected to access a computer network via a service provider, which arrangement includes hardware means and/or software products organized to authorize or block transmission of the data stream to the terminals as a function of particular criteria applied to the received data stream at the private access node.

One particular embodiment of the arrangement according to the invention is an equipment unit upstream of or at the input of the communication network node, for example a private automatic branch exchange.

The invention, its features and its advantages are explained in the following description, which is given with reference to the figures listed below.

### BRIEF DESCRIPTION OF THE DRAWING

FIG. 1 is a block diagram showing the general principle of controlling access to the Internet from user terminals via a private access node.

FIG. 2 is a block diagram of an access control arrangement in accordance with the invention.

### DETAILED DESCRIPTION OF THE PREFERRED EMBODIMENT

The access control method according to the invention is intended to be used in the context of a system in which terminals are made are available to users within an organization, such as a company, in particular in order to enable them to access a computer network, such as the Internet, for exchanging diverse information, such as multimedia information transmitted in the form of digital data. It is more particularly intended that the terminals access the computer network via a private access node connected to the network via at least one service provider, usually referred to as an Internet service provider (ISP) in the case of the Internet.

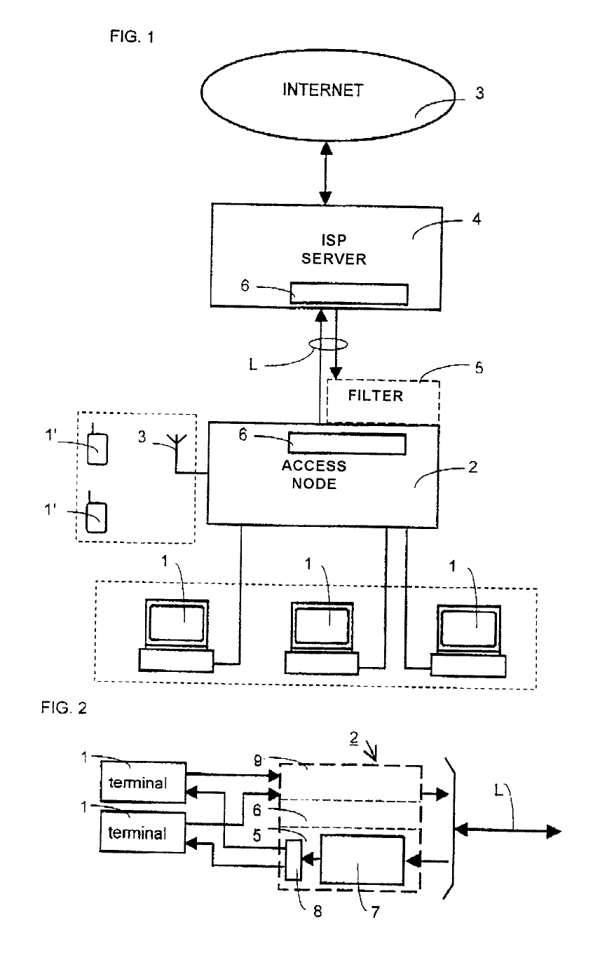

This is shown diagrammatically in FIG. 1, which shows in symbolic form two types of terminal that can be made available to users in a particular organization. The terminals 1 are computers, for example, connected by cables to an access node 2 and the terminals 1′ are computer terminals, for example, communicating by radio with the access node 2, which in this case is provided with transceiver means symbolized here by an antenna 3.

The access node 2 can take various forms, depending on what is required. Whichever option is chosen, it provides a routing function to enable terminals employed by users, such as the terminals 1 and 1′, to access a computer network 3, here considered to be the Internet. It is connected to a server 4 of an Internet service provider, such as an ISP server, via a transmission link L.

The access node 2 is a digital private automatic branch exchange (PABX), for example, to which terminals of a private telecommunication installation specific to an organization such as a company are connected by cables and/or possibly by wireless links. The PABX includes routing means enabling it to communicate in packet mode with an ISP server of an Internet service provider. The server acts as an intermediary vis-à-vis terminals in the telecommunication installation able to access the Internet. The access node 2 can also be a gateway which has a routing function and acts as an interface for terminals able to access the Internet, which are included in a local area network (LAN).

The invention provides an upstream or input filter arrangement 5 for monitoring data sent back by the computer network 3 via the server 4 to any terminal 1 or 1′ that has requested access to the network 3. Depending on the configurations provided, and the types of operation available, the filter arrangement 5 can be localized to the access node 2 or the server 4 or constitute a separate unit. Whichever option is chosen, it is an upstream or input unit and it is therefore able to intercept all information intended for terminals served by the access node and transmitted from the computer network 3 via the server 4 in response to requests to access the network submitted by those terminals, as shown symbolically in FIG. 1.

The filter arrangement 5 is more or less directly connected to the programmed control logic 6 of at least one of the subsystems consisting of the access node 2 and the server 4, in either of which it can be incorporated. As indicated above, a private access node 2 can be a node specific to a particular organization which uses it for its requirements or a node shared by several organizations and made available by a specialist company, for example.

The access control method according to the invention is intended to intervene only at the level of return traffic addressed to the terminals of the access node 2 where it is applied. It could of course be adapted to operate at the level of more than one access node and in connection with more than one server, to the benefit of the same organization, as envisaged above, the example shown diagrammatically in FIG. 1 being in no way to be considered as limiting on the invention.

The control method does not intervene at the time of setting up a call from a terminal 1 or 1′ to the server 4 of a service provider and via the access node 2 in the context of a request for access to the computer network 3 submitted by the terminal. As is known in the art, the programmed control logic of the access terminal includes information storage means enabling it to retain the information that is necessary for its routing function to direct the flow of data incoming from the computer network in response to an access request submitted by a terminal. The arrangement for implementing the method according to the invention can be associated with a “firewall” device for prohibiting the sending of particular requests by the terminals to the computer network and blocking access to data from particular sites and/or sites of a particular type.

In accordance with the invention, data transmitted from the computer network to a terminal is stored temporarily before it is transmitted to the terminal. As indicated above, this temporary storage can be effected at various levels of the system, including the server or servers 4 and the node 2 serving the terminal 1 or 1′ concerned.

In the embodiment shown diagrammatically in FIG. 2, a subsystem 7 for temporarily storing data is connected to the transmission link L at the access node 2 which receives the data from the computer network 3 via the link L and addressed to terminals connected at that time to the network. As assumed above, the storage subsystem 7 can be located at the server via which data from the network is supplied to the access node, especially if all access from the terminals served by the node is effected via the same server. Multimedia data streams received from the computer network via the link L pass through the temporary storage subsystem 7 before they are transmitted via a distribution interface 8 to the terminals to which they are addressed. The temporary storage device consists of one or more hard disk storage units, for example.

Filtering is then applied, by means of filtering and analysis logic, at the level of data specific to each of the streams received temporarily present in the storage device 7. It is assumed here that the logic is included in the control logic 6 that controls the node 2 and in particular the distribution interface 8 and the concentration interface 9 for grouping the streams of data emanating from terminals addressed to the server for transmission via the link. The filtering can be specifically tailored to the requirements of a client organization and/or user organization to enable it to monitor the use of the means providing access to the computer network 1 that it makes available to users at the terminals it assigns them.

Following a request to access the computer network freely effected by a user by means of a terminal and via an access node equipped with a control arrangement adapted to implement the method according to the invention, the data stream that is received for the user's terminal is analyzed in the temporary storage device 7 to which the stream is sent. The analysis and filter means used are, for example, chosen from the means known to the skilled person or implemented specifically, for example to seek a particular content of information in the whole of a received data stream addressed to a terminal or in specific parts thereof. The searching can be effected systematically or on a one-off basis at the level of a data stream, for example on the fly or periodically. It can also be effected in the context of particular configurations, for example if the number of ports active simultaneously is large or if some terminals have priority or some received information has priority. The whole or part of a received data stream is normally stored temporarily only for long enough to analyze it, and this is therefore undetectable by the user under these conditions and in particular if the data addressed to a user constitutes a large volume of data. The time needed for the analysis is generally very much less than the time needed to transmit all of the data from the computer network to the access node via the link L under present-day conditions. If the analysis process proves efficient, and reveals that one of the chosen filter criteria applies to the data received in the context of a stream addressed to a user, a decision is taken by means of the control logic concerned. That decision leads, for example, to a “no transmission” decision which blocks transmission of the data stream to the destination terminal, especially if it is feared that what is received represents a certain risk or contains information whose communication is not allowed, according to the criteria of the client and/or user organization. This blocking can be accompanied by interruption of the received data stream, at local initiative, in particular in the case of data likely to constitute a risk to the terminals, the node and/or possibly the server. It need not be accompanied by interruption of the received data stream in some cases, especially if there is some doubt as to the legitimate nature of the transmission to the user who requested it of the content that the received data constitutes. The received data can then be stored temporarily until it has been received in full. Its onward transmission can then be delayed temporarily until a decision concerning its legitimacy has been taken, possibly after human intervention, and transmission to the user can then be allowed or blocked permanently. The legitimacy check is effected, for example, in accordance with predetermined norms that apply under particular conditions, via the control logic. In some conditions, and in particular by virtue of predefined priorities, the transmission of some content can be delayed to the benefit of content considered to have priority, or possibly suspended as the result of a local decision at the level of the node or the server, by intentional interruption of the data streams used to transmit them.

In one embodiment of the method data received from the computer network that is not transmitted to a user after an analysis has led to a “no transmission” decision is retained, so that the data can be used to speed up the decision-making process if that data is received again in a subsequent stream, without re-analyzing the data received again. A decision can then be taken for a new incoming data stream in the event of identity of a selected set of newly received data with a particular set of stored data. It is also possible to retain information appearing in the stream and relating to the source of a data stream so that the information can be exploited if found again in a subsequent data stream to enable that subsequent data stream to be interrupted before the data that it carries has been analyzed in full, should this be justified.

In a different embodiment, the transfer of data received from the computer network to a destination terminal is temporarily delayed in the temporary storage means pending determination of conformance with what has been received, against particular norms. Data stored in the conformance determination phase for a given data stream can also be retained to enable a complementary check in the case of non-conformance. This relates, for example, to data received for a data stream up to the time at which non-conformance is detected. It can also be applied for all of the data received via a data stream without interrupting the data stream.

The content check that can be carried out in the context of the access control method according to the invention can also be used for purposes other than authorizing transmission, on the fly or with a controlled time-delay, of the data transmitted from the computer network to a terminal that has set up access to that network via the access node and a server. For example, it is possible to apply filtering relative to data characteristic of a particular information content, for example a particular file type, in particular for counting the number of times that the group of data characteristic of a particular content is received at the node, for traffic control purposes and/or for cost control purposes, in the case of content that is charged for,

The control arrangement can also be provided with essentially software means enabling it to carry out signature analysis operations on the data of a data stream received from the network in order to be able to block temporarily or permanently the transmission of data to a destination terminal if that data incorporates a characteristic signature. A signature can indicate the existence of restrictions on the use of the data that it accompanies, for example. This is known in the art, and applies in particular to SDMI (secure digital music initiative) signatures accompanying data constituting certain multimedia files.

An analysis can instead be carried out to look for identifiers in order to authorize the transmission of data received from the computer network in the context of a data stream if that data contains one or more particular identifiers. An identifier is introduced on creating a set of data, for example, such as a file, intended to be transmitted with the aim of authenticating the source of that set. In the embodiment envisaged here, its recognition at the receiver, in an access control arrangement according to the invention, is used to authorize and possibly initiate the transmission of all of the received data that it accompanies to the destination terminal.

As indicated above, implementing the method according to the invention entails using appropriate hardware and software means compatible with the communication installation concerned. Those means are not described further here, because they are well known to the skilled person. The arrangement itself takes the form of an equipment unit intended to be placed at the input of, or possibly upstream of, the node of the communication network, for example, to control the data supplied to that node addressed to user terminals served by that node.

There is claimed:

1. A method of providing access control for and/or vis-à-vis users who access a computer network enabling exchange of information, in particular the Internet, by means of terminals, via a private access node, shared or specific to an organization, such as a company, to which said terminals are connected to access said computer network via an access server, which method stores temporarily for downstream filtering the stream of multimedia data received from said computer network addressed to a user terminal in response to an access request formulated from said terminal, said downstream filtering being applied by an arrangement for authorizing or blocking transmission of said data stream to said terminal as a function of particular criteria applied to the received data stream at said private access node.

2. The method claimed in claim 1 wherein said data received from said computer network is stored temporarily before it is transmitted to said user terminal or not, depending on the results of an analysis.

3. The method claimed in claim 2 wherein data received from said computer network that is not transmitted, following an analysis that leads to a decision not to transmit it to said user, is retained so that said data can be compared with data of a subsequent data stream to accelerate decision-making in the case of identical data in different data streams, for a particular set of data, without having to carry out a further analysis corresponding to that which led to the data that is retained not being transmitted.

4. The method claimed in claim 1 wherein transfer of data received from said computer network to a user terminal is temporarily delayed in said temporary storage means pending determination of conformance of what has been received with particular standards and then transmitted to said terminal if conformance is found.

5. The method claimed in claim 4 wherein temporarily delayed data relating to a data stream stored in the conformance determination phase is retained to enable a further check in the event of non-conformance, either in respect of data received on detection of non-conformance, in which case the data stream that transmits it from said computer network is interrupted, or in respect of all of the data received, without said data stream being interrupted.

6. The method claimed in claim 4 wherein data for which and/or for the source of which non-conformance has been detected in a received data stream is retained to enable interruption of a data stream subsequently received before complete analysis of the data that said data stream transmits if said data and/or said source are detected again in said stream subsequently received.

7. The method claimed in claim 1 including counting, for control purposes, a particular content, consisting of a characteristic combination of data, if said content is found in said temporarily stored data, after it has been received from said computer network in at least one data stream addressed to a particular terminal.

8. The method claimed in claim 2 including signature analysis for at least temporarily blocking transmission of data received from said network to a user terminal if said data incorporates a signature characteristic of restricted signaling rights.

9. The method claimed in claim 2 including an identifier search analysis applied to received data addressed to a user terminal to authorize transmission of said data to said terminal if one or more particular identifiers are found in the received data addressed to said terminal.

10. An arrangement for providing access control for and/or vis-à-vis users who access a computer network enabling exchange of information, in particular the Internet, from terminals via a private access node that is shared or specific to an organization, such as a company, and to which said terminals are connected to access a computer network via a service provider, which arrangement includes hardware means and/or software products organized to authorize or block transmission of said data stream to said terminals as a function of particular criteria applied to said received data stream at said private access node.
